(19) United States
(12) Patent Application Publication
(10) Pub. No.: US 2025/0079434 A1
(43) Pub. Date: Mar. 6, 2025

(54) DRY ELECTRODE AND A METHOD OF MANUFACTURING THE SAME

(71) Applicants: HYUNDAI MOTOR COMPANY, Seoul (KR); KIA CORPORATION, Seoul (KR)

(72) Inventors: Hyun Jin Kim, Daegu (KR); Han Nah Song, Suwon-si (KR)

(73) Assignees: HYUNDAI MOTOR COMPANY, Seoul (KR); KIA CORPORATION, Seoul (KR)

(21) Appl. No.: 18/590,638

(22) Filed: Feb. 28, 2024

(30) Foreign Application Priority Data
Sep. 4, 2023 (KR) 10-2023-0117067

(51) Int. Cl. H01M 4/04; H01M 4/02; H01M 4/36; H01M 4/62

(52) U.S. Cl. CPC H01M 4/045; H01M 4/0407; H01M 4/366; H01M 4/623; H01M 2004/027

(57) ABSTRACT

A method of manufacturing a dry electrode includes forming a protective layer on a surface of an electrode active material, and mixing the electrode active material, a conductive material, and a binder.

### CROSS-REFERENCE TO RELATED APPLICATION

This application claims under 35 U.S.C. § 119(a) the benefit of and the priority to Korean Patent Application No. 10-2023-0117067 filed on Sep. 4, 2023, the entire contents of which are incorporated herein by reference.

### TECHNICAL FIELD

The present disclosure relates to a dry electrode of a battery and a method of manufacturing the dry electrode.

### BACKGROUND

Recently, the application of rechargeable secondary batteries is expanding in various fields from small electronic devices to large energy storage systems. In particular, research and development on the secondary batteries is being actively conducted due to the rapid growth of an electric vehicle market.

Electrodes for a secondary battery have typically been manufactured through a wet process. In the wet process, a slurry is produced by dissolving an electrode active material, a binder, and a conductive material included in the electrode with a solvent. However, recently, a dry process has been receiving great attention as the dry process may increase an energy density of the battery compared to the wet process without using the solvent required in the wet process.

In the dry process of the electrode, a dry electrode film is formed by mixing the electrode active material, the conductive material, and the binder without a solvent to form a mixture and then by forming a film by a pressing or calendaring method. Then the manufacture of the electrode may be finished by bonding the formed dry electrode film to a current collector.

Compared to the wet electrode manufacturing process, since the dry electrode manufacturing process may reduce a manufacturing time and cost because the dry electrode manufacturing process does not use the solvent and control a film formation thickness, a dry electrode film with a high energy density may be acquired.

However, since no solvent is used in the dry process, a binder different from the binder used in the wet process, which may connect electrode materials, is required.

### SUMMARY OF THE DISCLOSURE

The present disclosure has been made in efforts to solve the above problem and provides an electrochemically stable dry electrode and a method of manufacturing the same.

An object of the present disclosure is not limited to the above-described object, and other objects that are not mentioned should be clearly understood by one having ordinary skill in the art to which the present disclosure pertains from the following description.

The characteristics of the present disclosure for achieving the object of the present disclosure and performing characteristic functions of the present disclosure, which are described below, are as follows.

According to an embodiment of the present disclosure, a method of manufacturing a dry electrode includes forming a protective layer on a surface of an electrode active material and mixing the electrode active material on which the protective layer is formed, a conductive material, and a binder.

According to another embodiment of the present disclosure, a dry electrode mixture includes the electrode active material on which the protective layer is formed on the surface thereof, the binder, and the conductive material.

According to the present disclosure, the electrochemically stable dry electrode and the method of manufacturing the same are provided.

Effects of the present disclosure are not limited to the above-described effects, and other effects that are not mentioned should be clearly understood by those having ordinary skill in the art from the following description.

It should be understood that the term “automotive” or “vehicular” or other similar term as used herein includes motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the disclosure are discussed infra.

### BRIEF DESCRIPTION OF THE DRAWINGS

The above and other features of the present disclosure are now described in detail with reference to certain examples thereof illustrated in the accompanying drawings, which are given herein below for illustration only and thus do not limit the present disclosure, and wherein:

FIGS. 1A and 1B are scanning electron microscopy (SEM) images of a dry anode film;

FIG. 1C is a schematic diagram illustrating the dry anode film;

FIG. 2 is a view illustrating a change in a capacity of the dry anode film as a charge-discharge cycle proceeds;

FIG. 3 is a schematic diagram illustrating the dry anode film according to the present disclosure;

FIG. 4 is a view illustrating a protective layer forming apparatus for manufacturing the dry anode film according to an embodiment of the present disclosure;

FIG. 5 is a view illustrating a manufacturing flowchart of the dry anode film according to an embodiment of the present disclosure;

FIG. 6 is an enlarged view illustrating a region V1 in FIG. 3;

FIGS. 7A and 7B are views illustrating transmission electron microscopy (TEM)-energy dispersive spectroscopy (EDS) images of a comparative example for the dry anode film according to the present disclosure;

FIG. 7C is a view illustrating a mapping image for each element in FIG. 7B;

FIGS. 8A and 8B are views illustrating the TEM-EDS images of the dry anode film according to the present disclosure;

FIG. 8C is a view illustrating a mapping image for each element in FIG. 8B; and

FIG. 9 is a view illustrating the presence of peaks according to the decomposition of polytetrafluoroethylene (PTFE) of the dry anode film according to the present disclosure.

It should be understood that the appended drawings are not necessarily to scale and present a somewhat simplified representation of various features illustrating the basic principles of the disclosure. The specific design features of the present disclosure as disclosed herein, including, for example, specific dimensions, orientations, locations, and shapes should be determined in section by the particular intended application and use environment.

In the figures, same reference numbers refer to the same or equivalent sections of the present disclosure throughout the several figures of the drawings.

### DETAILED DESCRIPTION

Specific structural or functional descriptions presented in the embodiments of the present disclosure are merely exemplified for the purpose of describing the embodiments according to the concept of the present disclosure, and the embodiments according to the concept of the present disclosure may be implemented in various forms. In addition, the present disclosure should not be construed as being limited by the embodiments described in the present disclosure, and it should be understood that the disclosure includes all modifications, equivalents, or substitutes included in the spirit and technical scope of the present disclosure.

Meanwhile, in the present disclosure, the terms such as first and/or second may be used to describe various components, but the components are not limited by the terms. The above terms are used only for the purpose of distinguishing one component from another, for example, without departing from the scope of the present disclosure according to the concept of the present disclosure. A first component may be referred to as a second component, and similarly, the second component may also be referred to as the first component.

When a certain component is described as being “connected” or “coupled” to another component, it should be understood that the certain component may be directly connected or coupled to another component, or other components may also be disposed therebetween. On the other hand, when a certain component is described as being “directly connected” or “directly coupled” to another component, it should be understood that other components are not disposed therebetween. Other expressions for describing the relationship between components, such as “between” and “directly between” or “adjacent to” and “directly adjacent to” should be construed in the same manner.

The same reference numbers denote the same or equivalent components throughout the present disclosure. Meanwhile, terms used in the present disclosure are for describing the embodiments and are not intended to limit the present disclosure. In the present disclosure, the singular form also includes the plural form unless specifically stated in the phrase. As used herein, “comprises” and/or “comprising” means that the stated component, step, operation, and/or element do not preclude the presence or addition of one or more other components, steps, operations, and/or elements.

Hereinafter, the present disclosure is described in detail with reference to the accompanying drawings.

A dry electrode may be manufactured from a dry electrode mixture and a current collector without a solvent. The dry electrode mixture is a mixture of an electrode active material, a conductive material, and a binder. The dry electrode mixture may be manufactured into a dry electrode film through a series of film forming processes in which heat and a pressure are applied. The dry electrode film may be manufactured into a dry electrode through laminating with a current collector.

The dry electrode may be a cathode or an anode. In some embodiments, when the cathode is manufactured, the electrode active material includes a cathode active material. As a non-limiting example, the cathode active material may be nickel manganese cobalt (NMC) series, lithium ferrophosphate (LFP), lithium cobalt (LCO), or sulfur. For example, the cathode active material may include a layered compound, such as lithium cobalt oxide (LiCoO₂) or lithium nickel oxide (LiNiO₂), a compound substituted with one or more transition metals, a chemical formula Li₁₊ₓMn₂₋ₓO₄ (here, x is in a range of 0 to 0.33), lithium manganese oxides, such as LiMnO₃, LiMn₂O₃, and LiMnO₂, lithium copper oxide (Li₂CuO₂), vanadium oxides, such as LiV₃O₈, LiFe₃O₄, V₂O₅, and Cu₂V₂O₇, Ni site type lithium nickel oxide expressed as a chemical formula LiNi₁₋ₓMxO₂ (here, M=Co, Mn, Al, Cu, Fe, Mg, B or Ga and x is in a range of 0.01 to 0.3), lithium manganese complex oxide expressed as a chemical formula LiMn₂₋ₓMₓO₂ (here, M=Co, Ni, Fe, Cr, Zn or Ta and x is in a range of 0.01 to 0.1) or Li₂Mn₃MO₈ (here, M=Fe, Co, Ni, Cu or Zn), LiMn₂O₄ in which a portion of Li in the chemical formula is substituted with an alkaline earth metal ion, lithium metal phosphate LiMPO₄ (here, M=Fe, CO, Ni, or Mn), a disulfide compound, Fe₂(MoO4)3, or the like. However, the cathode active material is not limited to above examples.

In some embodiments, when the anode is manufactured, the electrode active material includes an anode active material. As a non-limiting example, the anode active material is graphite series and may include silicon. For example, the anode active material may include carbon, such as non-graphitizable carbon and graphitic carbon, metal complex oxides, such as LiₓFe₂O₃ (0≤x≤1), LiₓWO₂ (0≤x≤1), SnₓMe₁₋ₓMe′_{y}O_{z} (Me: Mn, Fe, Pb, Ge, Me′: Al, B, P, Si, group 1, group 2, and group 3 elements of a periodic table, halogen, 0<x≤1, 1≤y≤3, 1≤z≤8), lithium metal, lithium alloy, silicon-based alloy, tin-based alloy, silicon-based oxides, such as SiO, SiO/C, and SiO₂, metal oxides, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅, conductive polymers, such as polyacetylene, a Li—Co—Ni-based material, or the like.

The conductive material may include a carbon-based material. For example, the conductive material may include various carbon-based materials, such as Super P, Ketjen Black, single-walled carbon nanotube (SWCNT), and multi-walled carbon nanotube (MWCNT). In addition, when the dry electrode for a solid-state battery is manufactured, the dry electrode mixture may further include a polyethylene oxide (PEO)-based polymer, oxide, and sulfide-based solid electrolyte.

The binder may be a material with a C—F bond, which is a mixture of carbon and fluorine, such as polytetrafluoroethylene (PTFE) or polyvinylidene fluoride (PVDF). Alternatively, the binder may include styrene butadiene rubber (SBR)/carboxy methyl cellulose (CMC) or polyacrylonitrile (PAN).

Generally, an anode manufactured by a wet process includes an anode active material such as graphite, a conductive material, and a binder. The anode may be manufactured by dissolving and dispersing the anode active material, the conductive material, and the binder in an aqueous solvent and then coating a mixture on a current collector such as copper foil. SBR and CMC are mainly used as binders in the wet process.

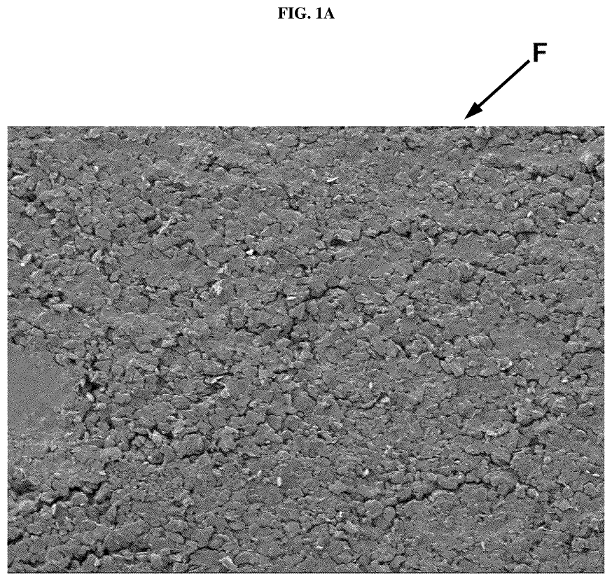

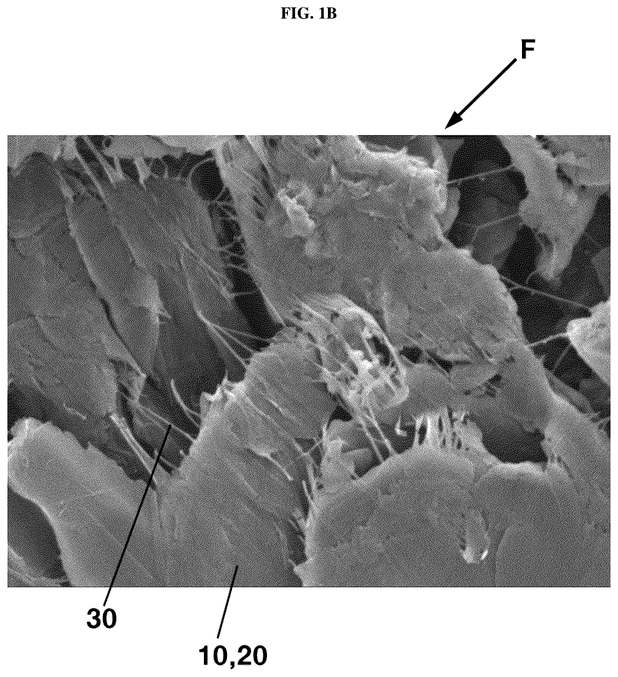

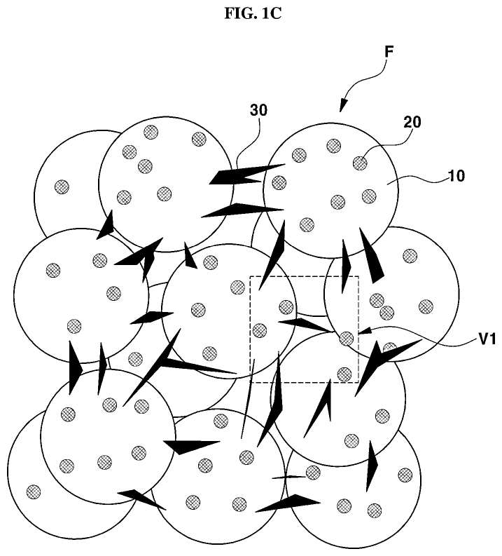

FIG. 1A is a view illustrating a scanning electron microscopy (SEM) image of a dry anode film F, FIG. 1B is a partial enlarged view illustrating the image in FIG. 1A, and FIG. 1C is a schematic diagram illustrating the dry anode film F. Referring to FIGS. 1A, 1, and 1C, the dry anode includes an anode active material 10, a conductive material 20, and a binder 30. In the illustrated example, the anode active material 10 and the conductive material 20 are evenly mixed, and the binder 30, such as PTFE, is fiberized in a skein shape. Thus, the dry anode may maintain the form of a free-standing film.

As described above, the same anode active material and conductive material as the wet anode may be used for the dry anode. However, since no solvent is used in the dry process, the binder in the wet process cannot be used. Instead, in the dry process, a binder connecting the electrode materials in the form of a network through fiberization should be used. For example, PTFE may be used as the binder of the dry electrode. By mixing the electrode materials and pressing a mixture through a roll press, the freestanding dry anode film may be acquired by PTFE. As in the illustrated example, it can be seen that PTFE is fiberized to maintain the electrode materials in the form of a film.

PTFE is a binder that makes it possible to manufacture the dry electrode. When PTFE is used in an anode, an irreversible chemical reaction as in Chemical formula 1 occurs in a reduction potential of the electrode.

(C₂F₄)ₙ+2nLi→nC (amorphous)+2nLiF [Chemical formula 1]

Here, C₂F₄ is a chemical formula of PTFE, n is an integer, C is carbon, Li is lithium, and F is fluorine.

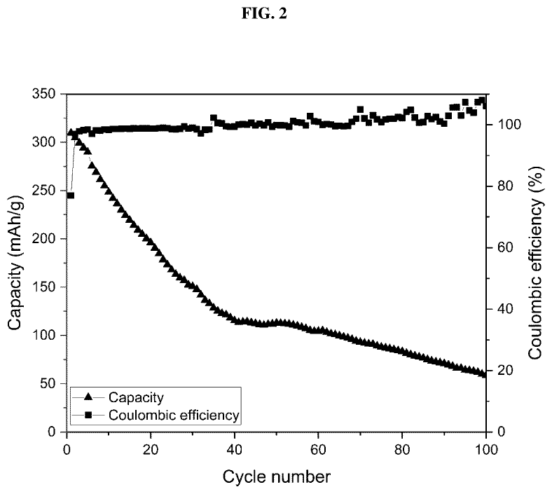

The decomposed PTFE may not function as a binder holding the electrode active material during charging and discharging due to a change in volume, as illustrated in FIG. 2, when charge-discharge cycles are repeated. A continuous decrease in capacity is observed, which has a negative effect on the deterioration of battery characteristics.

Therefore, the present disclosure intends to provide an electrochemically stable dry anode by forming a protective layer on a surface of an anode active material.

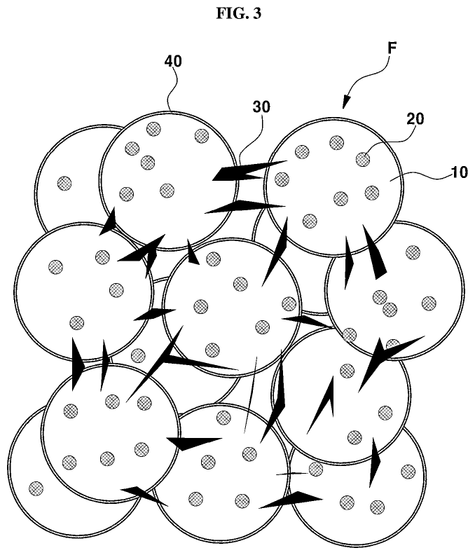

According to the present disclosure, as illustrated in FIG. 3, the dry anode includes a protective layer 40. The protective layer 40 may have electrical conductivity. The protective layer 40 may be formed, in particular, on a surface of the anode active material 10 of the dry anode. In one embodiment, the protective layer 40 formed on the anode active material 10 may be formed in advance before manufacturing a dry electrode mixture.

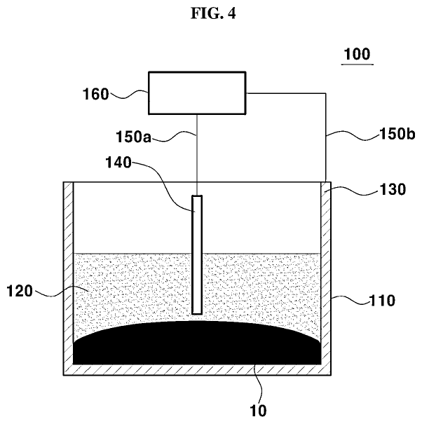

As illustrated in FIG. 4, according to an embodiment of the present disclosure, a protective layer forming apparatus 100 for forming the protective layer 40 on the anode active material 10 may be prepared.

The protective layer forming apparatus 100 includes a container 110. A material of the container 110 is not limited. As a non-limiting example, the container 110 may be formed of stainless steel, acrylic, or the like. In one embodiment, an inner surface of the container 110 is made of a material that is stable to the reduction reaction. For example, the inner surface of the container 110 may be made of copper, nickel, gold, or an alloy of these materials, which is used for a current collector of the anode. In other words, an outer surface of the container 110 may be made of any material, but the inner surface of the container 110, i.e., the surface in contact with an electrolyte is made of a material that is stable to the reduction reaction.

The container 110 is filled with an electrolyte 120. The electrolyte 120 may be an electrolyte with a composition same as an electrolyte used in a battery. The reason is to make the container identically or similarly to a solid electrolyte interphase (SEI) layer formed in a battery system. The SEI layer is a thin film formed on a surface of an anode when the manufactured battery is first charged. In some examples, the electrolyte used in the protective layer forming apparatus 100, i.e., participating in the electrochemical reaction may be re-used in the next process.

The electrolyte 120 within the container 110 includes additives. Here, the electrolyte 120 may be the same as a known electrolyte generally used in batteries. The electrolyte 120 may be a single component-based electrolyte or a multi component-based electrolyte. For example, 1 molar concentration (M) of lithium salt LiPF₆ may be dissolved in carbonate-based one-component or two-component solvents EC/DEC (1:1 v/v %) and EC/DMC (1:1 v/v %) or dissolved in a three-component solvent EC/DMC/DEC (1:1:1 v/v/v %). The lithium salt may be used variously depending on the purpose, such as LiBF₄, LiASF₆, LiClO₄, LiCF₃SO₃, and LiTFSI and used singly or in combination. A concentration of the lithium salt may also vary depending on a system, such as 0.01 to 10 M. An additive may include fluoroethylene carbonate (FEC), vinylene carbonate (VC), or a combination thereof. FEC may be added within 20 wt % based on an amount of the electrolyte 120 within the container 110. When FEC is added in excess of 20 wt %, the effectiveness of the protective layer 40 can be reduced. According to the present disclosure, the decomposition reaction of PTFE can be prevented by forming the protective layer 40 using the additive before the SEI layer is formed when the battery is first charged.

The anode active material 10 is accommodated in the container 110 filled with the electrolyte 120. The anode active material 10 is a material to be used in the dry electrode.

The protective layer forming apparatus 100 also includes a working electrode 130 and a counterpart/reference electrode 140. In one embodiment, as the working electrode 130, copper, nickel, gold, or an alloy of these materials, which are materials forming the inner surface of the container 110 may be used. The container 110 itself may be used as the working electrode 130. The counterpart/reference electrode 140 may be suspended on the container 110 so that at least a portion thereof is immersed in the electrolyte 120 within the container 110. For example, the counterpart/reference electrode 140 may be a lithium metal plate.

The working electrode 130 and the counterpart/reference electrode 140 are each connected to a potentiostat 160 through conductors 150a and 150b. The anode active material 10 inside the container 110 may be charged and discharged through the working electrode 130, the counterpart/reference electrode 140, and the potentiostat 160.

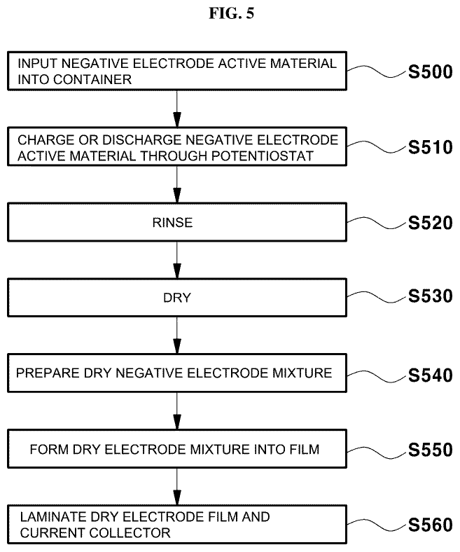

Referring to FIG. 5, according to some embodiments of the present disclosure, the protective layer 40 may be formed on the anode active material 10 through the protective layer forming apparatus 100.

The anode active material 10 is accommodated in the prepared container 110 filled with the electrolyte 120 including the additive at S500. A current is applied to the counterpart/reference electrode 140 and the working electrode 130 connected to the potentiostat 160 to generate an electrochemical reaction at S510. In other words, charging and discharging may be performed once on the anode active material 10 within the container 110. Taking graphite as an example, graphene has a layered structure in the graphite. Lithium ions are inserted between the graphene layers, and charging or intercalation is performed on the lithium ions. Therefore, a SEI layer may be formed while the electrolyte and the additive decompose. After the SEI layer is formed, the lithium ions inserted between the graphene layers are removed through discharge or deintercalation. Therefore, graphite into which the protective layer 40 is induced may be obtained.

The electrochemical reaction conditions, i.e., the charge-discharge conditions of the anode active material 10 may be determined based on a mass (e.g., in a unit of gram) and a theoretical capacity (e.g., in a unit of milliampere hour per gram (mAh/g)) of the anode active material 10 input into the container 110. A capacity of the input anode active material 10 may be determined by multiplying the mass of the input anode active material 10 by the theoretical capacity. For example, a theoretical capacity of the input anode active material graphite is 372 mAh/g. When 1 g is input, the capacity becomes 372 mAh.

A C-rate, which denotes a charge/discharge speed, may be applied as a value between 0.05 C (capacity) and 1 C. Within this range, the anode active material 10 may maintain a stable protective layer. The C-rate is expressed as the reciprocal of the applied time. For example, 0.1 C denotes 10 hours, and 1 C denotes 1 hour. In the above example, when the C-rate is selected as 1 C, this means that a constant current of 372 mA is applied for 1 hour. When the C-rate is selected as 0.1 C, this means that a constant current of 37.2 mA is applied for 10 hours. Meanwhile, the electrochemical reaction is finished when a voltage is cut off in a range of 0.01 to 0.05 V during charging and in a range of 1 to 2.5 V during discharging.

After charging and discharging are finished, the anode active material 10 is rinsed at S520. The rinsing is performed for the purpose of removing the lithium salt, the electrolyte, contaminants, and the like that may remain on the surface of the anode active material 10. The rinsing of the anode active material 10 may be performed with a low viscosity solvent among solvents of the electrolyte 120. For example, when the electrolyte 120 is a 2-component electrolyte ethylene carbonate (EC)/diethyl carbonate (DEC), the anode active material is rinsed with the DEC. This is to minimize the influence of the electrolyte. The solvent for the electrolyte is generally formed of a mixture of cyclic carbonate and linear carbonate due to the relationship between dielectric constant and viscosity. For the rinsing of the anode active material, the linear carbonate with low viscosity may be used, which can minimize the influence on the formed protective layer 40. In some examples, battery systems using ether-based electrolytes may be rinsed with an ether-based solvent. The rinsing may be configured so that the electrolyte flows to the anode active material without external energy being applied.

After the rinsing process, the anode active material 10 is dried at S530. A drying temperature may be a room temperature. In some examples, a maximum temperature at which drying is possible may be lower than about 60 degrees Celsius. This is because, when the temperature exceeds about 60 degrees Celsius, the protective layer 40 may be affected. In some examples, the drying may be performed in a dry room atmosphere or an argon atmosphere and performed using a vacuum.

Therefore, the protective layer 40 may be formed on the anode active material 10. The anode active material 10 on which the protective layer 40 is formed may be used to manufacture the dry electrode.

The dry anode mixture may be manufactured into the dry anode film F through a series of film forming processes in which heat and a pressure are applied (S540). The dry anode mixture is acquired by mixing the anode active material 10 on which the protective layer 40 is formed, the conductive material 20, and the binder 30. The dry anode mixture may be mixed by a mixer at a preset time and speed. As a non-limiting example, the dry electrode mixture may be prepared through a high shear mixer using rotation or a fluid mixer using air. The preset time and speed may be adjusted through changes in a rotational speed and an operating time of the mixer.

The prepared dry anode mixture is input into the film forming process and formed into a film at S550. One or more roll presses may be used in the film forming process. For example, the mixed dry anode mixture may be primarily pressed by a primary roll press and formed into the film. Subsequently, the filmed dry anode mixture may be additionally pressed by a secondary roll press where a thickness thereof may be adjusted through the pressing. Therefore, the dry anode mixture may be formed into the dry anode film F.

The dry anode film F may be finished as the dry anode through a lamination process with the current collector at S560.

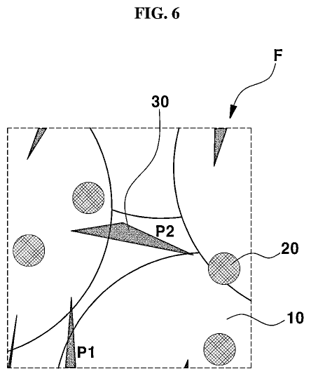

Referring to FIG. 6, the dry anode film F includes the anode active material 10, the conductive material 20, and the binder 30, as described above. The anode active material 10 and the conductive material 20 are evenly mixed. PTFE, which is a binder, is fiberized in a skein shape to maintain the form of a free-standing film.

In the dry anode film including PTFE, as described above, the properties as a binder are lost due to decomposition of PTFE. The anode active material 10 is separated from the current collector, resulting in a decrease in the electrode capacity. Describing a phenomenon that occurs in the anode in this process, it can be seen that the binder (position P1) in contact with the surface of the anode active material 10 is decomposed, but the binder (position P2) not in contact with the anode active material 10 does not participate in the decomposition reaction.

Based on this observation, according to the present disclosure, the surface of the anode active material is protected by the protective layer 40 with electrical conductivity. As another method, a fine structure may be grown on the anode active material by coating a conductive polymer having an ethylene oxide unit on the anode active material or through processes, such as atomic layer deposition (ALD) or chemical vapor deposition (CVD). However, in this case, there are difficulties in that the coating is thick, resulting in loss of an energy density of the electrode and a process cost is high.

Without using this process, according to the present disclosure, it is possible to solve the above-described problems and prevent a decrease in the capacity of the electrode using the SEI layer forming mechanism of the battery.

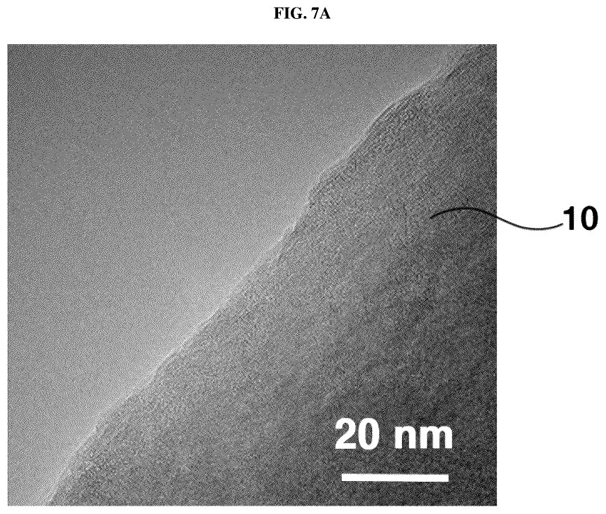

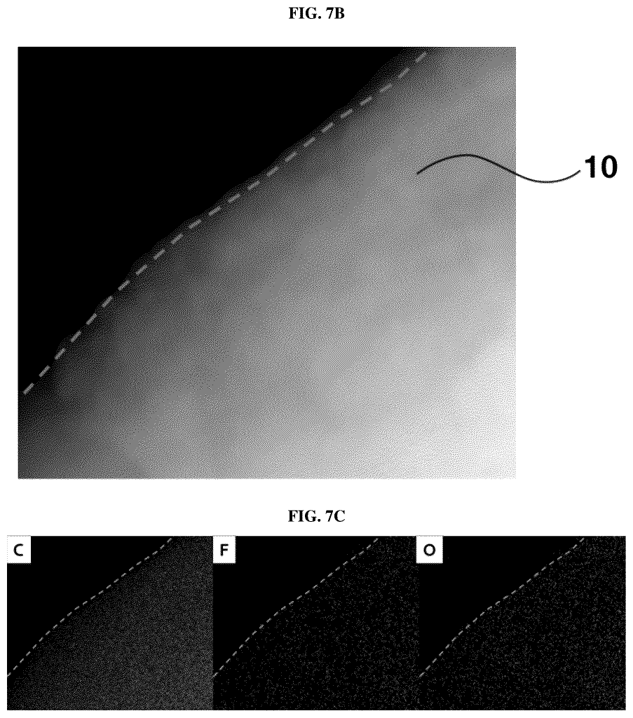

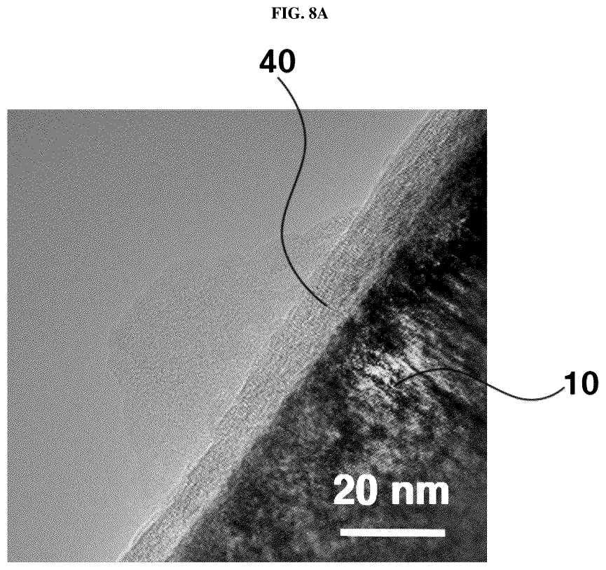

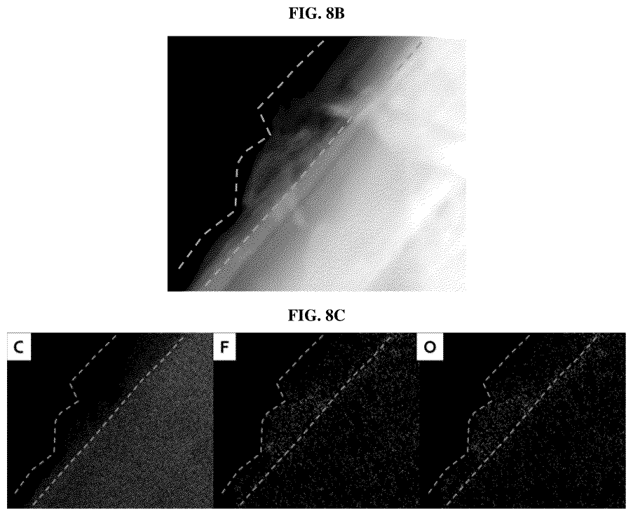

As illustrated in FIGS. 7A, 7B, 8A, and 8B, it can be seen that the protective layer 40 is formed on the anode active material 10 according to the present disclosure. FIG. 7A is a view illustrating a transmission electron microscopy (TEM)-energy dispersive spectroscopy (EDS) image of the anode active material undergoing rinsing and drying without applying a current to the anode active material input into the container 110 through the potentiostat 160 in the protective layer forming apparatus 100. FIG. 8A is a view illustrating a TEM-EDS image of the anode active material 10 charged and discharged by applying the current in the same condition as in FIG. 7A. In FIG. 7A, no structure can be seen on the surface of the anode active material 10 (see FIGS. 7B and 7C), while in FIG. 8A, unlike a crystalline structure of graphite, which is the anode active material 10, it can be seen that an amorphous layer is formed (see FIG. 8B). In addition, it can be seen that C, F, and O are contained through mapping (see FIG. 8C). This is a layer (containing LiF and —CHF—OCO₂— compound or the like) containing LiF formed through FEC, which is an additive. It can be seen that the formed protective layer 40 has a thickness in a range of several nanometers to tens of nanometers.

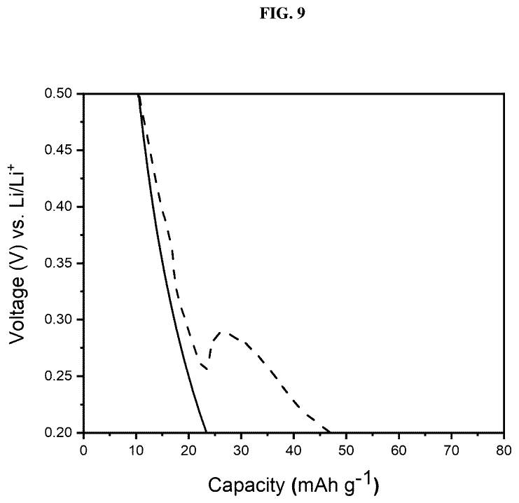

FIG. 9 is a view illustrating data on the dry anode film made of graphite including the protective layer 40 according to the present disclosure. In the experiment on this data, the anode active material 10 was graphite, the binder 30 was PTFE, and a weight ratio of the anode active material 10 to the binder 30 was 98.5:1.5. The manufactured dry anode film was laminated on a copper foil after the dry anode was manufactured. Then an electrode punched into a circle with a diameter of 10 millimeters was used. A half-cell was manufactured by using the dry anode film as the working electrode, using lithium metal as the counterpart/reference electrode, using 1 molar concentration (M) of LiPF₆ in EC/DEC (volume ratio of EC:DEC is 1:1) as the electrolyte, and using 10 wt % of FEC as the additive. A charge-discharge condition of the half-cell is a cut-off at 0.01V/0.05C after 0.1 C is discharged in a constant current (CC)/constant voltage (CV) mode, and a cut-off at 1.5 V after 0.1 C is charged in the CC mode.

A PTFE decomposition reaction peak of a first cycle in which lithium ions intercalate with graphite can be seen at an initial 0.1 C. A dotted line graph represents the dry anode film without forming the protective layer 40, and a peak due to the PTFE decomposition can be seen. The PTFE decomposition peak was observed between 0.5 and 0.1 V. A solid line graph relates to the dry anode film according to the present disclosure on which the protective layer 40 is formed, and it can be seen that no peak due to the PTFE decomposition is observed.

According to the present disclosure, it is possible to control side reactions even while using PTFE as the binder by inducing the formation of the protective layer on the anode active material.

The present disclosure is not limited by the above-described embodiments and the accompanying drawings, and it should be apparent to those having ordinary skill in the art to which the present disclosure pertains that various substitutions, modifications, and changes are possible without departing from the scope of the technical spirit of the present disclosure.

What is claimed is:

1. A method of manufacturing a dry electrode, the method comprising:
forming a protective layer on a surface of an electrode active material; and
mixing the electrode active material on which the protective layer is formed, a conductive material, and a binder.

2. The method of claim 1, wherein forming the protective layer includes:
arranging the electrode active material within an electrolyte accommodated in a container, wherein the electrolyte includes an additive; and
executing charging and discharging of the electrode active material.

3. The method of claim 2, wherein charging and discharging of the electrode active material are executed by applying a voltage through a working electrode and a counterpart/reference electrode operably associated with the container.

4. The method of claim 2, further comprising: rinsing the electrode active material after charging and discharging of the electrode active material are executed.

5. The method of claim 4, wherein the electrolyte is a single component-based electrolyte or a multi component-based electrolyte, and rinsing in the multi component-based electrolyte is performed with an electrolyte with a lowest viscosity among the multi component-based electrolytes.

6. The method of claim 4, further comprising: drying the electrode active material after the rinsing.

7. The method of claim 2, wherein the additive is fluoroethylene carbonate (FEC), vinylene carbonate (VC), or a combination thereof.

8. The method of claim 2, wherein a condition of charging and discharging the electrode active material is determined based on a mass and a theoretical capacity of the electrode active material.

9. The method of claim 1, further comprising: filming a dry electrode mixture in which the electrode active material, the conductive material, and the binder are mixed.

10. The method of claim 1, wherein the electrode active material is an anode active material, and the binder is made of polytetrafluoroethylene (PTFE).

11. A dry electrode mixture comprising:
an electrode active material having a surface on which a protective layer is formed;
a binder; and
a conductive material.

12. The dry electrode mixture of claim 11, wherein:
the protective layer is formed by a protective layer forming apparatus including:
a container having a working electrode and configured to receive the electrode active material,
an electrolyte accommodated in the container and having an additive;
a counterpart/reference electrode having at least a portion immersed in the electrolyte; and
a potentiostat connected to the working electrode and the counterpart/reference electrode and configured to apply a voltage to the working electrode and the counterpart/reference electrode.

13. The dry electrode mixture of claim 12, wherein the additive is fluoroethylene carbonate (FEC), vinylene carbonate (VC), or a combination thereof.

14. The dry electrode mixture of claim 12, wherein the working electrode is made of copper, nickel, gold, or alloys thereof, and the counterpart/reference electrode is made of lithium metal.

15. The dry electrode mixture of claim 11, wherein the electrode active material is an anode active material, and the binder is made of polytetrafluoroethylene (PTFE).

16. The dry electrode mixture of claim 11, wherein the protective layer is formed by the dry electrode mixture by mixing the electrode active material, the binder, and the conductive material.

17. A protective layer forming apparatus, including:
a container having a working electrode and configured to receive an electrode active material of a dry electrode mixture;
an electrolyte, accommodated in the container and having an additive;
a counterpart/reference electrode, having at least a portion immersed in the electrolyte; and
a potentiostat connected to the working electrode and the counterpart/reference electrode and configured to apply a voltage to the working electrode and the counterpart/reference electrode.

18. The protective layer forming apparatus according to claim 17, wherein the additive is fluoroethylene carbonate (FEC), vinylene carbonate (VC), or a combination thereof.

19. The protective layer forming apparatus according to claim 17, wherein the working electrode is made of copper, nickel, gold, or alloys thereof, and the counterpart/reference electrode is made of lithium metal.

20. The protective layer forming apparatus according to claim 17, wherein the electrode active material is an anode active material.
